(19) United States
(12) Patent Application Publication
(10) Pub. No.: US 2023/0142066 A1
(43) Pub. Date: May 11, 2023

(54) NAIL GUN PROVIDED WITH WIDE AND NARROW NAIL SWITCHING AND NAIL BLOCKING STRUCTURE

(71) Applicant: Hangzhou Kelong Electric Devices Co. Ltd., Hangzhou (CN)

(72) Inventors: Guomin YAN, Hangzhou (CN); Xiaoming Kang, Hangzhou (CN)

(73) Assignee: Hangzhou Kelong Electric Devices Co. Ltd., Hangzhou (CN)

(21) Appl. No.: 17/522,956

(22) Filed: Nov. 10, 2021

(51) Int. Cl. B25C 1/08

(52) U.S. Cl. CPC B25C 1/08

(57) ABSTRACT

A nail gun is provided with a wide and narrow nail switching and nail blocking structure provided with a nail rail. The nail gun includes a punching sheet guide rail vertically arranged in front of the nail rail, the punching sheet guide rail defining a positioning groove. One side of the positioning groove extends upwards to form a groove A in which a regulating block is arranged in a sliding manner, and another side of the positioning groove extends downwards to form a groove B in which a nail blocking bar is rotatably arranged through a pin shaft, wherein the nail blocking bar is capable of rotating between an initial position and a terminating position around the pin shaft. A spring sheet presses against the nail blocking bar. A toggle button is vertically arranged in front of the regulating block to selectively clamp and press against the regulating block.

### TECHNICAL FIELD

The present disclosure relates to the field of tools, and in particular to a nail gun provided with a wide and narrow nail switching and nail blocking structure.

### BACKGROUND

Nail gun is also called a powder actuated tool. Since the appearance and the working principle are similar to a pistol, the nail gun is often called a nail shooting gun. In the European and American nail gun markets, nail shooting guns are not only professional tools, but also suitable for ordinary families and individuals to carry out simple decoration. However, existing nail guns are categorized into narrow nail dedicated guns and wide nail dedicated guns, a user needs to match the nail width with a nail gun, which is inconvenient; in the meanwhile, the nail legs are easy to skew during the nailing process, resulting in a poor quality of nailing.

The patent with application number of CN102785223B provides a nail guide structure and a nail gun having the same. This structure to some extent can solve the problem that the nail legs are easy to skew during the nailing process. However, the employed support element moves horizontally in the positioning groove of the guide plate under the action of the elastic element, the horizontal movement distance is not definite, which may not block the nails. There are still problems of nail leg skew during and after the nailing process or nail stuck.

### SUMMARY

The present disclosure aims to overcome the defects existing in the prior art, and provide a nail gun provided with a wide and narrow nail switching and nail blocking structure, which enables two different nail widths on one same nail gun and has a nail blocking function.

The aim of the present disclosure is accomplished through the following scheme: a nail gun provided with a wide and narrow nail switching and nail blocking structure, wherein the structure is arranged in a nail gun provided with a nail rail, the nail gun includes a punching sheet guide rail vertically arranged in front of the nail rail, wherein the punching sheet guide rail includes a first surface and a second surface opposite to the first surface, the first surface of the punching sheet guide rail faces the nail rail, the punching sheet guide rail defines a positioning groove running through the first surface and the second surface, the first surface further defines a vertical extending guide groove, such that a punching sheet arranged right above the punching sheet guide rail and/or a nail arranged in the nail rail slide(s) linearly along the guide groove; one side of the positioning groove extends upwards to form a groove A in which a regulating block is arranged in a sliding manner, such that the regulating block is capable of sliding between a first position and a second position, the regulating block includes an end A and an end B, wherein when the regulating block is located at the first position, the end A extends out of the first surface, when the regulating block moves towards the second position, the end A is close towards the first surface; another side of the positioning groove extends downwards to form a groove B in which a nail blocking bar is rotatably arranged, wherein the nail blocking bar is fixed through a pin shaft and is capable of rotating between an initial position and a terminating position around the pin shaft, the nail blocking bar includes an end C and an end D, wherein when the nail blocking bar is located at the initial position, the end C extends out of the first surface, and when the nail blocking bar rotates towards the terminating position, the end C is close towards the first surface; a spring sheet presses against the end D, such that the nail blocking bar always tends to reset to the initial position; a toggle button is vertically arranged in front of the regulating block to selectively clamp and press against the regulating block, such that the regulating block cannot move to the second position.

In a preferred embodiment, the toggle button is fixedly mounted in a toggle button sleeve and is capable of moving up and down with the toggle button sleeve.

In a preferred embodiment, the toggle button is provided with a protrusion to adapt to a convex plate arranged on the end B of the regulating block; when the toggle button moves downwards with the toggle button sleeve, the protrusion presses against the convex plate, such that the end A of the regulating block extends out of the first surface to form a narrow nail outlet gap; when the toggle button moves upwards with the toggle button sleeve, the protrusion keeps away from the convex plate, such that the end A of the regulating block retracts to the groove A, to form a wide nail outlet gap.

In a preferred embodiment, the narrow nail outlet gap is 0.75 mm, and the wide nail outlet gap is 1.2 mm.

In a preferred embodiment, the toggle button defines a through groove for the end D of the nail blocking bar to pass through, and a tail part of the spring sheet enters the through groove to press against the end D of the nail blocking bar.

In a preferred embodiment, the nail blocking bar is provided with a stopper part, the stopper part is close to the end C and is located outside the outline of the groove B; when the nail blocking bar is located at the initial position, the stopper part presses against the punching sheet guide rail, such that the nail blocking bar cannot completely fall out of the groove B from the first surface.

The present disclosure has the following beneficial effects: the nail outlet gap is changed by changing the position of the toggle button, such that the gap between the nail rail and the punching sheet guide rail changes freely between 0.75 mm and 1.2 mm, thereby enabling wide and narrow nails to be used on one same nail gun; in the meanwhile, two nail blocking bars are arranged in the groove of the punching sheet guide rail and they will block nails all the time during the nailing process, so as to improve the nailing quality of the wide nails.

### BRIEF DESCRIPTION OF THE DRAWINGS

FIG. 1 is a stereo structure diagram of the present disclosure.

FIG. 2A is a partial stereo exploded view of the present disclosure.

FIG. 2B is a stereo view of a punching sheet guide rail of the present disclosure in another view.

FIG. 3 is a partial stereo view of the present disclosure.

FIG. 4 is a partial sectional view of the present disclosure.

FIG. 5 is a stereo view when a regulating block is located at a first position.

FIG. 6 is a sectional view when a regulating block is located at a first position.

FIG. 7 is a stereo view when a narrow nail is used.

FIG. 8 is a sectional view when a narrow nail is used.

FIG. 9 is a stereo view when a wide nail is used.

FIG. 10 is a sectional view when a wide nail is used.

Descriptions of designators in drawings: 1 represents a punching sheet guide rail, 11 represents a first surface, 12 represents a second surface, 13 represents a positioning groove, 14 represents a guide groove, 15 represents a groove A, 16 represents a groove B, 2 represents a punching sheet, 3 represents a nail, 31 represents a nail back, 32 represents a nail leg, 4 represents a regulating block, 41 represents an end A, 42 represents an end B, 43 represents a convex plate, 5 represents a nail blocking bar, 51 represents an end C, 52 represents an end D, 53 represents a stopper part, 6 represents a pin shaft, 7 represents a spring sheet, 8 represents a toggle button, 81 represents a protrusion, 82 represents a through groove, 9 represents a toggle button sleeve, and 10 represents a nail rail.

### DETAILED DESCRIPTION

The present disclosure is described below in detail in conjunction with drawings.

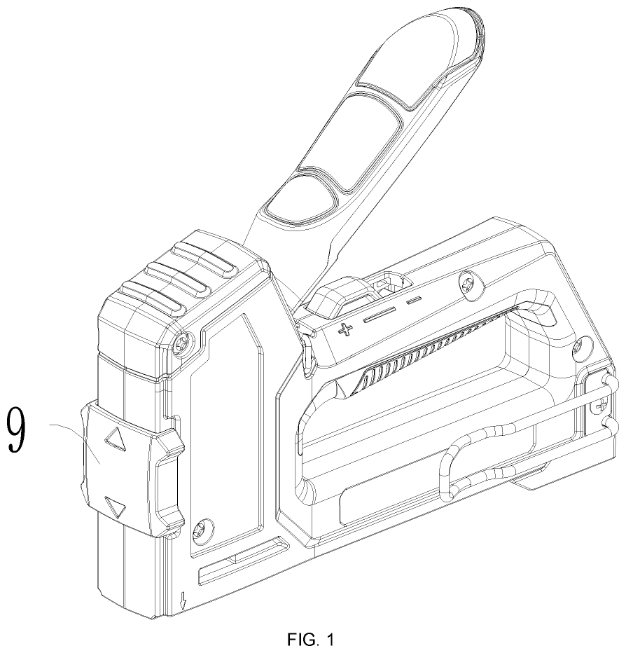

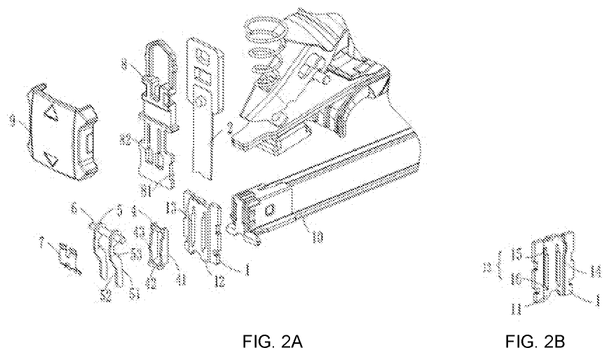

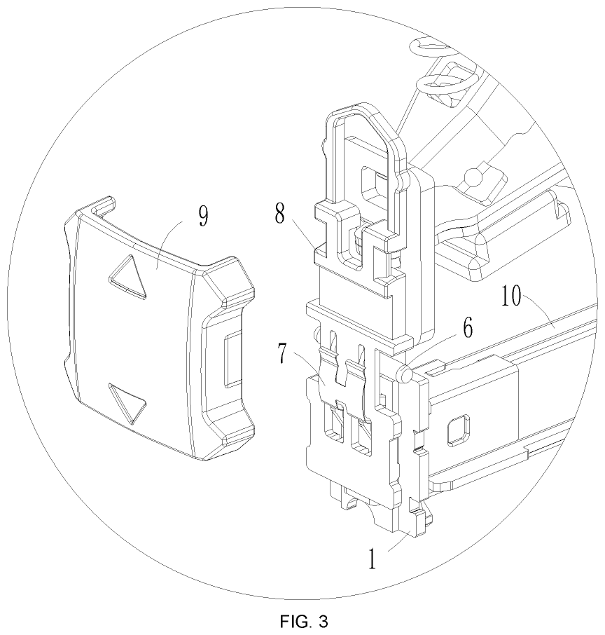

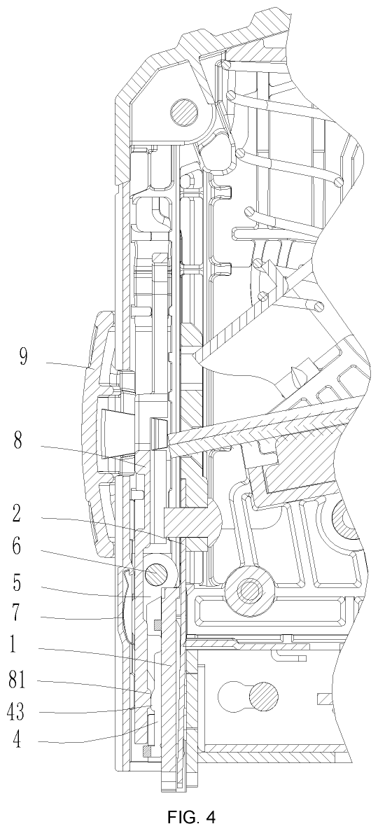

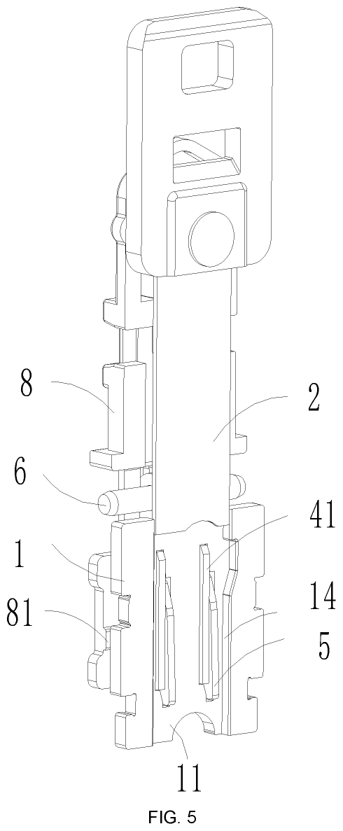

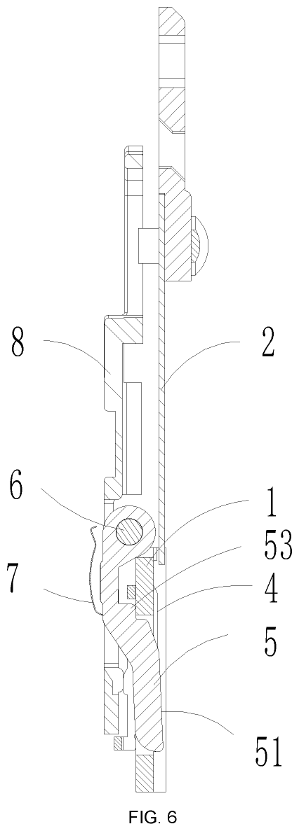

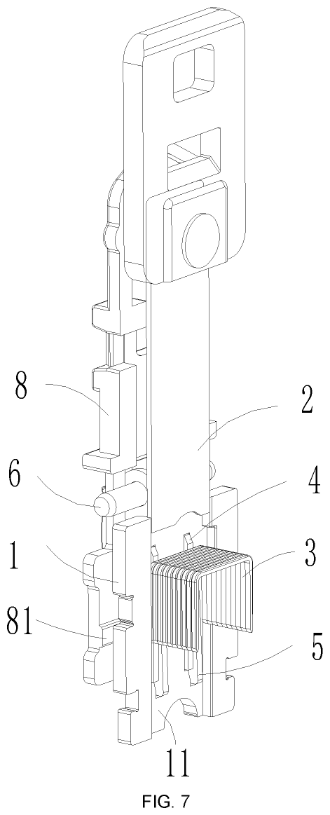

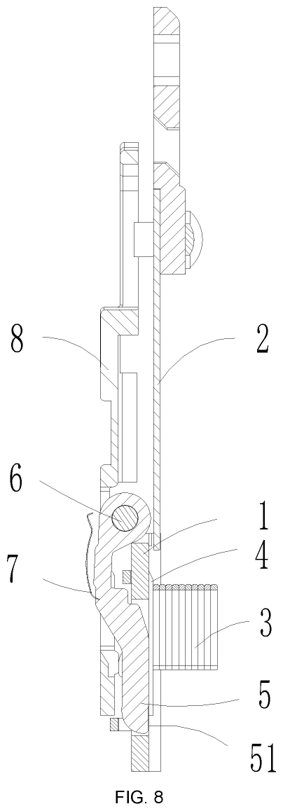

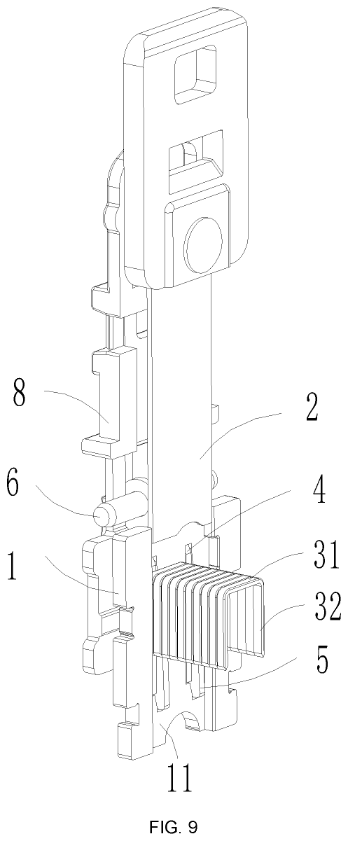

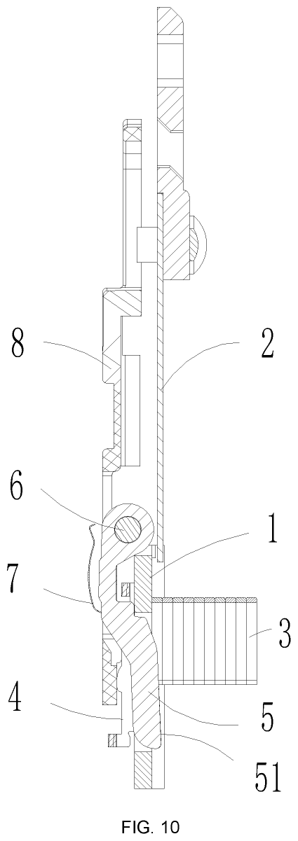

Embodiments: as shown in FIG. 1 to FIG. 4, the present disclosure provides a nail gun provided with a wide and narrow nail switching and nail blocking structure, wherein the structure is arranged in a nail gun provided with a nail rail 10, the nail gun includes a punching sheet guide rail 1 vertically arranged in front of the nail rail 10, wherein the punching sheet guide rail 1 includes a first surface 11 and a second surface 12 opposite to the first surface 11, the first surface 11 of the punching sheet guide rail 1 faces the nail rail 10, the punching sheet guide rail 1 defines a positioning groove 13 running through the first surface 11 and the second surface 12, the first surface 11 further defines a vertical extending guide groove 14, such that a punching sheet 2 arranged right above the punching sheet guide rail 1 and/or a nail 3 arranged in the nail rail 10 slides linearly along the guide groove 14; one side of the positioning groove 13 extends upwards to form a groove A 15 in which a regulating block 4 is arranged in a sliding manner, such that the regulating block 4 is capable of sliding between a first position as shown in FIG. 7 and FIG. 9 and a second position as shown in FIG. 9 and FIG. 10, the regulating block 4 includes an end A 41 and an end B 42, wherein when the regulating block 4 is located at the first position (as shown in FIG. 5), the end A 41 extends out of the first surface 11, when the regulating block 4 moves towards the second position, the end A 41 is close towards the first surface 11 (preferably, levelled to the first surface 11); another side of the positioning groove 13 extends downwards to form a groove B 16 in which a nail blocking bar 5 is rotatably arranged, wherein the nail blocking bar 5 is fixed through a pin shaft 6 and is capable of rotating between an initial position as shown in FIG. 5 and FIG. 6 and a terminating position as shown in FIG. 8 around the pin shaft 5, the nail blocking bar 5 includes an end C 51 and an end D 52, wherein when the nail blocking bar 5 is located at the initial position (as shown in FIG. 5), the end C 51 extends out of the first surface 11, and when the nail blocking bar 5 rotates towards the terminating position, the end C 51 is close towards the first surface (preferably, levelled to the first surface 11); a spring sheet 7 presses against the end D 52, such that the nail blocking bar 5 always tends to reset to the initial position.

A toggle button 8 is vertically arranged in front of the regulating block 4 to selectively clamp and press against the regulating block 4, such that the regulating block 4 cannot move to the second position; the toggle button 8 is fixedly mounted in a toggle button sleeve 9 and is capable of moving up and down with the toggle button sleeve 9; the toggle button 8 is provided with a protrusion 81 to adapt to a convex plate 43 arranged on the end B 42 of the regulating block 4; when the toggle button 8 moves downwards with the toggle button sleeve 9, the protrusion 81 presses against the convex plate 43, such that the end A 41 of the regulating block 4 extends out of the first surface 11 (that is, the regulating block 4 moves to the first position) to form a narrow nail outlet gap; when the toggle button 8 moves upwards with the toggle button sleeve 9, the protrusion 81 keeps away from the convex plate 43, such that the end A 41 of the regulating block 4 retracts to the groove A 15 (that is, the regulating block 4 moves to the second position), to form a wide nail outlet gap; preferably, the narrow nail outlet gap is 0.75 mm, and the wide nail outlet gap is 1.2 mm.

The toggle button 8 defines a through groove 82 for the end D 52 of the nail blocking bar 5 to pass through, and a tail part of the spring sheet 7 enters the through groove 82 to press against the end D 52 of the nail blocking bar 5, such that the nail blocking bar 5 always tends to reset to the initial position.

The nail blocking bar 5 is provided with a stopper part 53, the stopper part 53 is close to the end C 51 and is located outside the outline of the groove B 16; when the nail blocking bar 5 is located at the initial position (as shown in FIG. 6), the stopper part 53 presses against the punching sheet guide rail 1, such that the nail blocking bar 5 cannot completely fall out of the groove B 16 from the first surface 11.

The working process of the present disclosure is as follows.

As shown in FIG. 7 and FIG. 8, when a user is to use a narrow nail, he/she first pushes down the toggle button sleeve 9 such that the toggle button 8 moves downwards, then the protrusion 81 on the toggle button 8 is attached on the convex plate 43 on the regulating block 4, such that the end A 41 of the regulating block 4 extends out of the first surface 11 (that is, the regulating block 4 moves to the first position), then the nail 3 directly presses against the regulating block 4, to form a narrow nail outlet groove (0.75 mm in this embodiment) in the guide groove 14 of the punching sheet guide rail 1 for the user to shoot a narrow nail.

As shown in FIG. 9 and FIG. 10, when a user is to use a wide nail, he/she pushes up the toggle button sleeve 9 such that the toggle button 8 move upwards, then the protrusion 81 on the toggle button 8 keeps away from the convex plate 43 on the regulating block 4, such that the end A 41 of the regulating block 4 moves leftwards and retracts to the groove A 15 (that is, the regulating block 4 moves to the second position), then the nail 3 directly contacts the first surface 11 of the punching sheet guide rail 1, to form a wide nail outlet groove (1.2 mm in this embodiment) in the guide groove 14 of the punching sheet guide rail 1 for the user to shoot a wide nail. During the process of shooting a wide nail, when the punching sheet 2 hits the nail 3, the nail 3 is shot along the guide groove 14 inside the punching sheet guide rail 1, the nail blocking bar 5 blocks on the nail legs 32 at two sides of the nail 3, and when the nail back 31 contacts the nail blocking bar 5, the nail blocking bar 5 rotates leftwards gradually along the pin shaft 6 in the groove B 16 of the punching sheet guide rail 1, and the nail blocking bar 5 compresses the spring sheet 7 until the nail 3 is completely shot; after the nail 3 is shot, the punching sheet 2 returns to the original position, the nail blocking bar 5 is restored to the initial position under the restoring force of the spring sheet 7; the nail blocking bar 5 blocks the nail all the time (applying a constant acting force to the nail back 31) when rotating along the pin shaft 6, preventing the occurrence of nail leg skew during and after the nailing process.

It is understandable that, for those skilled in the art, equivalent substitutions or modifications of the technical scheme and idea of the present disclosure shall be included in the scope of protection of claims appended hereinafter.

What is claimed is:

1. A nail gun provided with a wide and narrow nail switching and nail blocking structure, wherein the structure is arranged in a nail gun provided with a nail rail, the nail gun comprises a punching sheet guide rail vertically arranged in front of the nail rail, wherein the punching sheet guide rail comprises a first surface and a second surface opposite to the first surface, the first surface of the punching sheet guide rail faces the nail rail, the punching sheet guide rail defines a positioning groove running through the first surface and the second surface, the first surface further defines a vertical extending guide groove, such that a punching sheet arranged right above the punching sheet guide rail and/or a nail arranged in the nail rail slide(s) linearly along the guide groove; one side of the positioning groove extends upwards to form a groove A in which a regulating block is arranged in a sliding manner, such that the regulating block is capable of sliding between a first position and a second position, the regulating block comprises an end A and an end B, wherein when the regulating block is located at the first position, the end A extends out of the first surface, and when the regulating block moves towards the second position, the end A is close towards the first surface; another side of the positioning groove extends downwards to form a groove B in which a nail blocking bar is rotatably arranged, wherein the nail blocking bar is fixed through a pin shaft and is capable of rotating between an initial position and a terminating position around the pin shaft, the nail blocking bar comprises an end C and an end D, wherein when the nail blocking bar is located at the initial position, the end C extends out of the first surface, and when the nail blocking bar rotates towards the terminating position, the end C is close towards the first surface; a spring sheet presses against the end D, such that the nail blocking bar always tends to reset to the initial position; a toggle button is vertically arranged in front of the regulating block to selectively clamp and press against the regulating block, such that the regulating block cannot move to the second position.

2. The nail gun provided with a wide and narrow nail switching and nail blocking structure according to claim 1, wherein the toggle button is fixedly mounted in a toggle button sleeve and is capable of moving up and down with the toggle button sleeve.

3. The nail gun provided with a wide and narrow nail switching and nail blocking structure according to claim 1, wherein the toggle button is provided with a protrusion to adapt to a convex plate arranged on the end B of the regulating block; when the toggle button moves downwards with the toggle button sleeve, the protrusion presses against the convex plate, such that the end A of the regulating block extends out of the first surface to form a narrow nail outlet gap; when the toggle button moves upwards with the toggle button sleeve, the protrusion keeps away from the convex plate, such that the end A of the regulating block retracts to the groove A, to form a wide nail outlet gap.

4. The nail gun provided with a wide and narrow nail switching and nail blocking structure according to claim 3, wherein the narrow nail outlet gap is 0.75 mm, and the wide nail outlet gap is 1.2 mm.

5. The nail gun provided with a wide and narrow nail switching and nail blocking structure according to claim 1, wherein the toggle button defines a through groove for the end D of the nail blocking bar to pass through, and a tail part of the spring sheet enters the through groove to press against the end D of the nail blocking bar.

6. The nail gun provided with a wide and narrow nail switching and nail blocking structure according to claim 1, wherein the nail blocking bar is provided with a stopper part, the stopper part is close to the end C and is located outside the outline of the groove B; when the nail blocking bar is located at the initial position, the stopper part presses against the punching sheet guide rail, such that the nail blocking bar cannot completely fall out of the groove B from the first surface.
